(19) United States
(12) Patent Application Publication
(10) Pub. No.: US 2006/0153660 A1
(43) Pub. Date: Jul. 13, 2006

(54) Assembly with resilient member and method for assembling the same

(75) Inventor: Wen-Ping Chiu, Johngli City (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/290,575

(22) Filed: Dec. 1, 2005

(30) Foreign Application Priority Data
Dec. 3, 2004 (TW) 93137344

(51) Int. Cl. F16B 39/02

(52) U.S. Cl. 411/90

(57) ABSTRACT

An assembly including a first rigid member, a resilient member, a second rigid member, a first screw, and a second screw. The first rigid member includes a first screw hole. The resilient member includes a first surface and a second surface opposite to the first surface. The first surface abuts the first rigid member. The second rigid member abuts the second surface of the resilient member, and includes a second screw hole and a through hole. The first screw passes through the through hole and the resilient member to be threaded with the first screw hole. The second screw is threaded with the second screw hole, and passes through the resilient member to abut the first rigid member.

### BACKGROUND

The invention relates to a method for assembling an assembly with a resilient member, and in particular, to a method for preventing a screw from loosening during assembly with a resilient member.

Referring to FIG. 1, when a resilient member 2 is assembled between two rigid members 1 and 1′, a screw 3 is often fastened to one of the rigid members to fix the resilient member 2 between the rigid members 1 and 1′. Nevertheless, after a predetermined time has elapsed, the torsion of the screw 3 may decrease. That is, the screw 3 may loosen from the rigid member 1.

To prevent the screw from loosening, Nylok adhesive, elastic washers, or star washers are utilized. Since elastic fatigue or permanent deformation may be generated in the resilient member, internal tension of the screw may disappear. Thus, only Nylok friction or friction between teeth of the screw is remained to loosen the screw. Since such friction is much lower than normal torsion for loosening the locked rigid member, the screw may loosen.

### SUMMARY

An assembly with a resilient member is provided. An exemplary embodiment of an assembly comprises a first rigid member, a resilient member, a second rigid member, a first screw, and a second screw. The first rigid member comprises a first screw hole. The resilient member comprises a first surface and a second surface opposite to the first surface. The first surface abuts the first rigid member. The second rigid member comprises a second screw hole and a first through hole, and abuts the second surface of the resilient member. The first screw passes through the first through hole and the resilient member to be threaded with the first screw hole. The second screw is threaded with the second screw hole, and passes through the resilient member to abut the first rigid member.

Furthermore, the resilient member is adhered to the first rigid member. The resilient member comprises a second through hole which the first screw passes through, and a third through hole which the second screw passes through.

A method for assembling an assembly with a resilient member is provided. An exemplary embodiment of a method comprises the following steps. A first screw and a second screw are provided. The first screw is passed through the second rigid member and the resilient member to be fastened to the first rigid member. The second screw is fastened to the second rigid member to pass the resilient member and abut the first rigid member.

The method further comprises the following steps. Before the first screw is fastened to the first rigid member, the resilient member is adhered to the first rigid member. The first screw is fastened to the first rigid member until the first rigid member approaches the second rigid member.

### DESCRIPTION OF THE DRAWINGS

The invention can be more fully understood by reading the subsequent detailed description and examples with references made to the accompanying drawings, wherein:

FIG. 1 is a schematic view of a conventional assembly with a resilient member;

FIG. 2 is a schematic view of an embodiment of an assembly with a resilient member;

FIG. 3a is a schematic view of an embodiment of a method for assembling an assembly with a resilient member, wherein a relationship between a first rigid member and the resilient member is shown;

FIG. 3b is a schematic view of the method in FIG. 3a, wherein a relationship between a second rigid member and the resilient member is shown; and

FIG. 3c is a schematic view of the method in FIG. 3a, wherein first screws are fastened to the first rigid member.

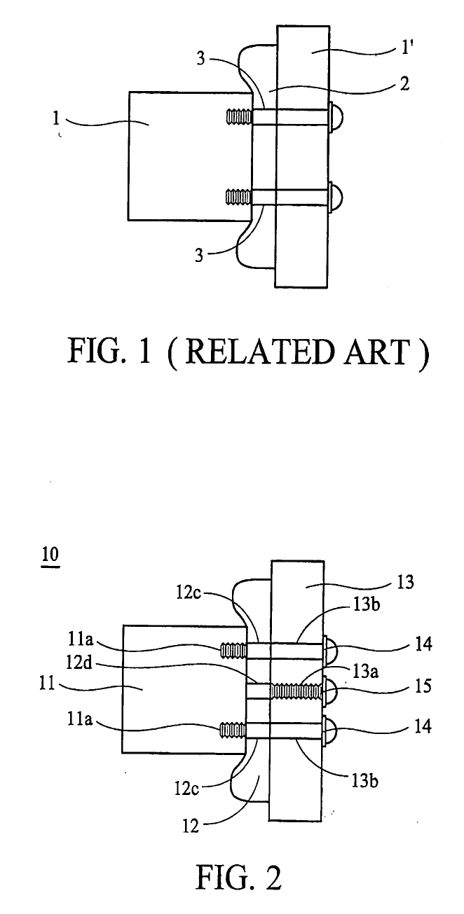

### DETAILED DESCRIPTION

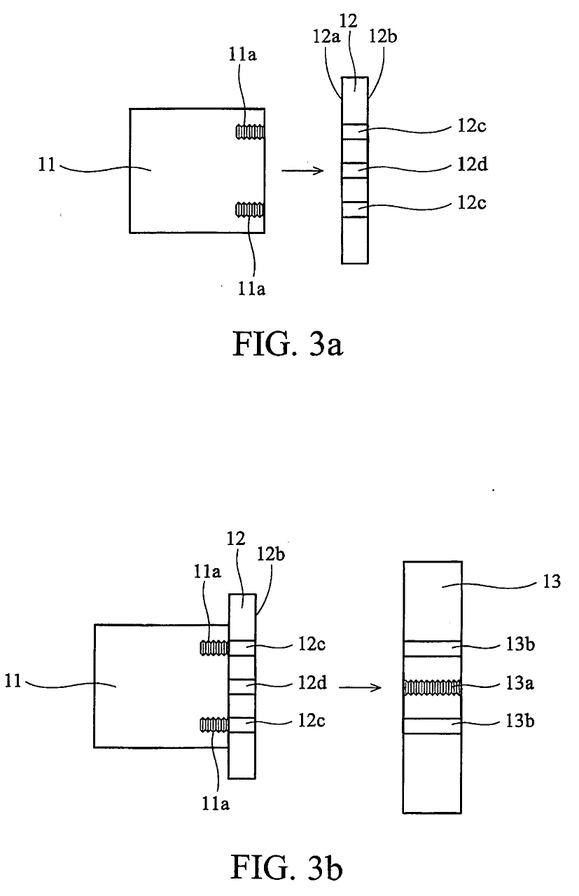

Referring to FIG. 2, an embodiment of an assembly 10 comprises a first rigid member 11, a resilient member 12, a second rigid member 13, two first screws 14, and a second screw 15.

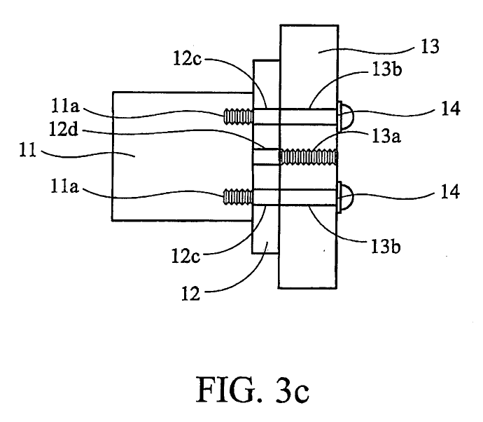

The first rigid member 11 comprises two first screw holes 11a at a side facing the resilient member 12. The resilient member 12 comprises a first surface 12a and a second surface 12b opposite to the first surface 12a. As shown in FIG. 3a, the first surface 12a abuts the first rigid member 11, and the second surface 12b abuts the second rigid member 13. The resilient member 12 further comprises two second through holes 12c which the first screws 14 pass through, and a third through hole 12d which the second screw 15 passes through. The third through hole 12d is preferably located between the second through holes 12c.

The second rigid member 13 comprises a second screw hole 13a and two first through holes 13b, and abuts the second surface 12b of the resilient member 12. The second screw hole 13a corresponds to the third through hole 12d of the resilient member 12, and each first through hole 13b corresponds to each second through hole 12c of the resilient member 12. Each first screw 14 passes through the first through hole 13b of the second rigid member 13 and the second through hole 12c of the resilient member 12 consecutively to be threaded with the first screw hole 11a of the first rigid member 11. The second screw 15 is threaded with the second screw hole 13a of the second rigid member 13, and passes through the third through hole 12d of the resilient member 12 to abut the first rigid member 11. Note that the number of first and second screws 14 and 15 is not limited to two and one respectively.

Referring to FIGS. 3a-3c, to assemble the assembly 10, the first surface 12a of the resilient member 12 is first adhered to the first rigid member 11, as shown in FIG. 3a. Then, as shown in FIG. 3b, the second rigid member 13 approaches and abuts the second surface 12b of the resilient member 12. Sequentially, as shown in FIG. 3c, the first screws 14 are passed through the first through holes 13b of the second rigid member 13 and the second through holes 12c of the resilient member 12 to be threaded with the first screw holes 11a of the first rigid member 11 until the first rigid member 11 approaches the second rigid member 13. Finally, as shown in FIG. 2, the second screw 15 is threaded with the second screw hole 13a of the second rigid member 13 to pass the third through hole 12d of the resilient member 12 and abut the first rigid member 11.

As previously described, the second screw 15 abuts the first rigid member 11 so that the first rigid member 11 may move away from the second rigid member 13. Conversely, the first screws 14 are fastened to the first rigid member 11 so that the first rigid member 11 may approach the second rigid member 13. Thus, the first screws 14 may always be under tension, and the second screw 15 may always be compressed. As a result, the first screws 14 may always be in contact with threads of the first screw holes 11a of the first rigid member 11, and the second screw 15 may always be in contact with threads of the second screw hole 13a of the second rigid member 13, thus avoiding loosening.

Furthermore, the distance between the first rigid member 11 and the second rigid member 13 may be kept constant by the second screw 15 so that the resilient member 12 may be compressed by a fixed pressure. Thus, the resilient member 12 may not be overly deformed maintaining its original function.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly comprising:
a first rigid member comprising a first screw hole;
a resilient member comprising a first surface and a second surface opposite to the first surface, wherein the first surface abuts the first rigid member;
a second rigid member, comprising a second screw hole and a first through hole, abutting the second surface of the resilient member;
a first screw passing through the first through hole and the resilient member to be threaded with the first screw hole; and
a second screw, threaded with the second screw hole, passing through the resilient member to abut the first rigid member.

2. The assembly as claimed in claim 1, wherein the resilient member is adhered to the first rigid member.

3. The assembly as claimed in claim 1, wherein the resilient member comprises a second through hole which the first screw passes through.

4. The assembly as claimed in claim 1, wherein the resilient member comprises a third through hole which the second screw passes through.

5. A method for assembling an assembly with a resilient member, a first rigid member, and a second rigid member, comprising:
providing a first screw and a second screw;
passing the first screw through the second rigid member and the resilient member to be fastened to the first rigid member; and
fastening the second screw to the second rigid member to pass the resilient member and abut the first rigid member.

6. The method as claimed in claim 5, further comprising:
adhering the resilient member and the first rigid member before the first screw is fastened to the first rigid member.

7. The method as claimed in claim 5, further comprising:
fastening the first screw to the first rigid member until the first rigid member approaches the second rigid member.
